(19) United States
(12) Patent Application Publication
(10) Pub. No.: US 2015/0222958 A1
(43) Pub. Date: Aug. 6, 2015

(54) DATA DISPLAY APPARATUS AND DATA DISPLAY METHOD

(71) Applicant: KABUSHIKI KAISHA TOSHIBA, Tokyo (JP)

(72) Inventor: Kazuhide SAWA, Akishima Tokyo (JP)

(21) Appl. No.: 14/577,851

(22) Filed: Dec. 19, 2014

Related U.S. Application Data
(60) Provisional application No. 61/934,050, filed on Jan. 31, 2014.

(51) Int. Cl. H04N 21/482; H04N 21/61; H04N 21/44; H04N 21/278; H04N 21/8405; H04N 21/234; H04N 21/4782; H04N 21/81

(52) U.S. Cl. CPC H04N 21/4828; H04N 21/4782; H04N 21/6125; H04N 21/8173; H04N 21/278; H04N 21/8405; H04N 21/23418; H04N 21/44008

(57) ABSTRACT

One embodiment provides a content-browseable data display apparatus. The apparatus includes: a browsing module which browses a content; an extracting module which extracts keywords therefrom; a displaying module selectably displays the keywords based on evaluation values therefor; and a searching module which performs a keyword search by using a keyword selected from the displayed keywords. As to a displaying region where the browsing module displays an HTML content, the displaying module performs filtering so as to scoop the keywords contained therein, and displays the scooped keywords.

### CROSS-REFERENCE TO RELATED APPLICATION(S)

This application claims priority from U.S. Provisional Patent Application No. 61/934,050 filed on Jan. 31, 2014, the entire contents of which are incorporated herein by reference.

### TECHNICAL FIELD

An embodiment of the present invention relates to a data display apparatus and method for displaying data which are received through the Internet.

### BACKGROUND ART

Recently, the use of the Internet on a television set is spreading, and there is a need for further consulting the Internet about information relating to displayed content. Many Internet content written in HTML are laid out on the assumption that they are displayed on a PC. When they are displayed on a television set, therefore, it sometimes occurs that characters seem too small. In such a case, it is usual to increase the character size, or expand the screen and display only a partial region on the screen. With respect to a mode of expressing a screen, there are many contents which are long in the vertical direction and thus are designated so as to be viewed through the scrolling manipulation. As a result, such content will be partly displayed on the screen.

In the browsing function for a television set, from the viewpoints of operability and improvement of merits of user experience, particularly, it is important to save the trouble of inputting a search keyword, because of the following reason. During browsing of Internet content displayed on a television set, the user often wishes to search for a keyword in which the user is interested on the display screen. However, inputting of characters through a remote controller is cumbersome, and therefore the user does not wish to actively use such an inputting function. In the case of an apparatus which operates based on an input through a pointer, such as a personal computer or a tablet computer, a keyword in which the user is interested on a page can be selected, and then the user can perform a search through copy and paste or a context menu. In a case of a remote controller, however, it is impossible to select a specific keyword, and therefore the operability is lower.

### BRIEF DESCRIPTION OF THE DRAWINGS

FIG. 1 is a block diagram showing a main signal processing system of a video display control apparatus of an embodiment.

FIG. 2 is a block diagram showing the configuration of a program for a content reception and display process.

FIGS. 3A to 3C are views illustrating examples of displaying keyword candidates in a display region by an Internet browser in the embodiment.

FIG. 4 is a view showing the flow of a keyword extraction process in a browser display range used in the embodiment.

FIG. 5 is a view showing an example of the flow of a keyword extraction process in the whole page in the embodiment.

FIG. 6 is a view showing an example of weighting of an HTML tag in the embodiment.

FIG. 7 is a view showing examples of extracted keywords to which layout information used in the embodiment is given.

### MODE FOR CARRYING OUT THE INVENTION

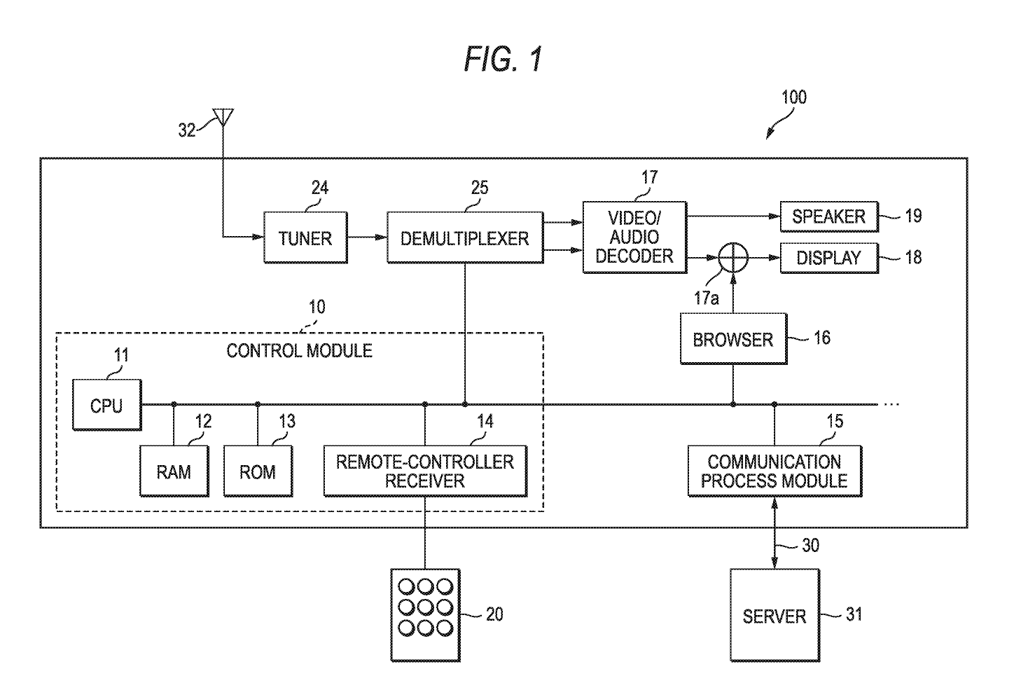

Hereinafter, an embodiment will be described with reference to the drawings. FIG. 1 is a block diagram schematically showing the configuration of a video display control apparatus 100 which will be described in the following embodiment. Specifically, the video display control apparatus 100 corresponds to a digital television receiver or set-top box which receives digital television broadcasting or the like, or a home server. In the embodiment, a digital television receiver will be described as an example.

The video display control apparatus 100 includes a control module 10 which includes, for example, a microprocessor, and which generally controls various operations. The control module 10 includes a CPU (Central Processing Unit) 11, a RAM (Random Access memory) 12, and a ROM 13. The RAM 12 is a memory which stores various data including data necessary for data processing in the CPU 11. The RAM 12 may operate as a buffer memory which stores data of content (for example, motion picture content) received from an external server. The ROM (Read Only Memory) 13 is a read only memory, and stores various data including programs for the CPU 11. The ROM 13 further stores programs for a browser 16, and application programs.

The video display control apparatus 100 includes a remote-controller receiver 14. The remote-controller receiver 14 receives manipulation information which is transmitted from, for example, a remote controller 20 functioning as a manipulation input device. The remote controller 20 transmits to the remote-controller receiver 14, a manipulation signal for delivering a manipulation desired by the user to the control module 10 by means of, for example, wireless communication using an infrared ray. The remote controller 20 includes various manipulation keys such as selection keys (up/down keys and right/left keys) for performing a selecting manipulation which is conducted by means of a cursor, and which will be described later, a decision key for performing a decision manipulation, and a termination key for terminating an EPG display and a browser screen.

The video display control apparatus 100 includes a communication process module 15, the browser 16, a video/audio decoder 17, a display 18, and a speaker 19. The communication process module 15 is connected to the Internet 30, and configured so as to be accessible to an external server 31 through the Internet 30. Then, the communication process module 15 performs processes of conducting information communication of HTML content (data of web pages including motion picture contents, still picture contents, text contents, and the like) with the server 31.

The browser 16 is configured by various kinds of software and the like, and includes processes such as production of a browser screen and reproduction of a motion picture. Based on an HTML tag contained in the HTML content received from the server 31, the browser constructs (produces) an HTML content display image which is used for displaying the HTML content on the display 18, by a software program, and then outputs the image to an adder 17a. By the functions of the browser 16 and the control module 10, the video display control apparatus 100 displays the HTML content display image received from the server 31, on the display 18. The browser 16 includes a BML browser in addition to an HTML browser as described later.

A tuner 24 tunes a channel of a desired frequency from the broadcast wave which is received through an antenna 32, extracts a TS (Transport Stream), and outputs it to a demultiplexer 25.

The demultiplexer 25 transmits data (PSI (Program Specific Information)/SI (Service Information) of data broadcasting to the CPU 11. The CPU 11 controls the demultiplexer 25 so as to acquire a program which is selected by the user, from the data of the data broadcasting. Under the control of the CPU 11, the demultiplexer 25 sorts the TS into three kinds of data for each packet, i.e., data of video content of the program selected by the user, data of audio content, and data of the data broadcasting, and outputs two kinds of data, i.e., the data of video content and data of audio content to the video/audio decoder 17.

The video/audio decoder 17 outputs a video signal which is obtained by expanding and decoding the data of video content, to the adder 17a, and an audio signal which is obtained by expanding and decoding the data of audio content, to the speaker 19. Specifically, the video and audio signals output from the video/audio decoder 17 are converted through components such as a video processor and an audio processor which are not shown, and then guided to the adder 17a and the speaker 19, respectively. The adder 17a superimposes the output of the browser 16 on that of the video/audio decoder 17, and then outputs the result of the superimposition to the display 18.

The display 18 is a display device which reproduces the video signal which is expanded and decoded by the video/audio decoder 17, and the HTML content display image which is constructed by the browser 16, on a screen.

As described above, the video display control apparatus 100 of the embodiment has functions of receiving an HTML content of a web page formed by a service (so-called Internet service) using the Internet 30 and the server 31, and reproducing the content via the display 18 and the speaker 19, in addition to the function of receiving digital terrestrial broadcasting, BS broadcasting, CS broadcasting, and the like.

The server 31 in the embodiment includes a search engine, and realizes a service for searching an HTML content (a web page, an image file, network news, and the like) existing in the Internet. Alternatively, the server 31 may perform a service for distributing a motion picture such as a movie through a VOD (Video On Demand).

The control module 10 produces an EPG (not shown) which is to be displayed on the display 18, based on information of an electronic program guide (EPG) contained in the broadcast wave that is received through the antenna 32, and/or program information (EPG information) contained in the signal that is received from the server 31 through the communication process module 15. The EPG is displayed on the display 18 in response to a predetermined manipulation (for example, pressing a program guide button of the remote controller 20) performed by the user.

An EPG is expressed in a two-dimensional shape having: a channel axis along which plural channel display frames corresponding to services (broadcast stations) are horizontally arranged; and a time axis which is divided vertically into plural time frames corresponding to unit time periods (e.g., one hour) that are consecutive in time series. Various sets of information such as the titles and contents of programs scheduled to be broadcasted are displayed in regions (program cells) designated by the channel axis and the time axis. The names of the broadcast stations which are disposed on the channel axis in the EPG indicate program providers in digital terrestrial broadcasting, BS, CS, and the like that are received through the antenna 32.

The user manipulates the cursor on the EPG by using the up/down keys, right/left keys, and the like of the remote controller 20, or performs a decision manipulation, so that selection of viewing a program or reservation of recording a program can be conducted, or detail information of the program (information of the program content and the cast, and the like) can be obtained. In the embodiment, the EPG includes a manipulation guide (not shown) for the remote controller 20. For example, Guide B indicates that, when a blue button of the remote controller 20 is pressed during display of an EPG, an EPG including the present viewing time is displayed. Guide R indicates that, when a red button of the remote controller 20 is pressed, a GUI for promoting the user to designate the time and date of the EPG to be displayed is displayed, and the EPG of the desired time and date can be displayed in accordance with the GUI. Guide G indicates that, when a green button of the remote controller 20 is pressed, detail description of the program which is selected by the cursor 43 can be displayed. Guide Y indicates that, when a yellow button of the remote controller 20 is pressed, a function of performing a keyword search by using information of the program (program information) selected by the cursor can be executed. In the EPG, a program guide may be produced by using only the program information received from the server 31, or one program guide may be configured by combining the program information received from the server 31 with that received from the broadcast stations through the antenna 32.

The control module 10 performs a control for dividing the screen of the display 18 into at least a first screen region and a second screen region, and controls the display of various menus and GUI, and the like on the display 18. The control module 10 further performs a control for displaying the EPG in the first screen region, and information which is received from the server 31, and which relates to the program selected by the user, in the second screen region.

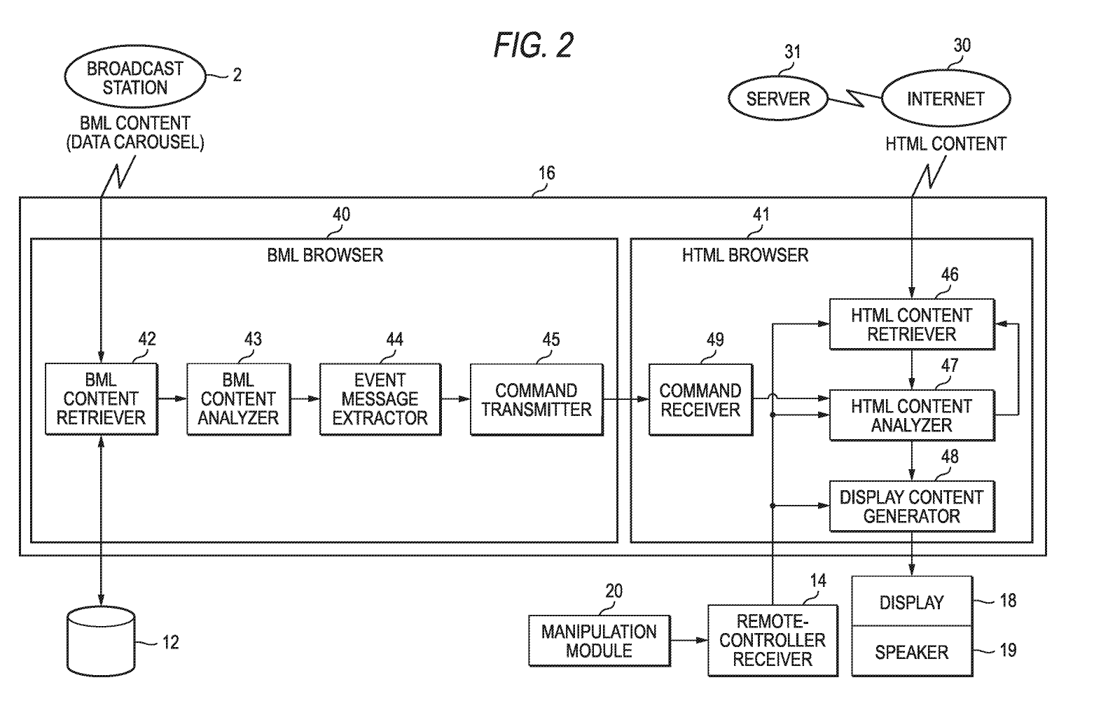

FIG. 2 is a block diagram showing the configuration of a program for a content reception and display process of the browser 16.

The BML (Broadcast Markup Language) browser 40 includes a BML content retriever 42, a BML content analyzer 43, an event message extractor 44, and a command transmitter 45.

The BML content retriever 42, which acquires a BML content as a content having a first format acquires, a BML content broadcasted from the broadcast station 2 with the data carousel method, and accumulates the BML content in the RAM 12. Next, the BML content analyzer 43 analyzes the BML content which is read out from the RAM 12 by the BML content retriever/reader 42.

Then, the event message extractor 44 extracts an event message from the BML content by using a result of the analysis of the BML content. The command transmitter 45 transmits a command to a command receiver 49 in an HTML browser 41 at a timing which is based on timing control information contained in the BML content.

The HTML (HyperText Markup Language) browser 41 includes an HTML content retriever 46, an HTML content analyzer 47, a display content generator 48, and the command receiver 49.

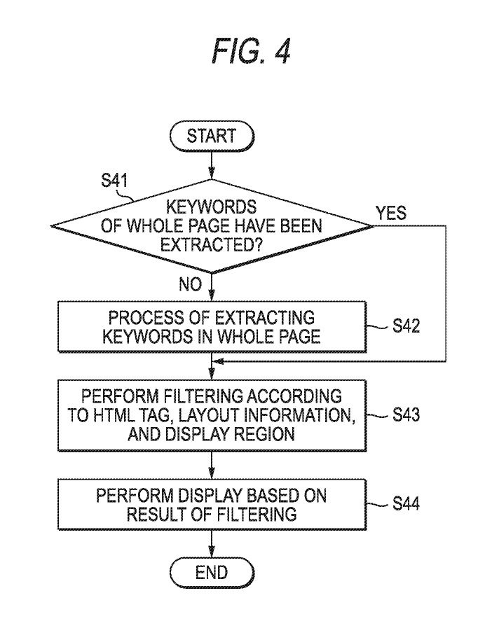

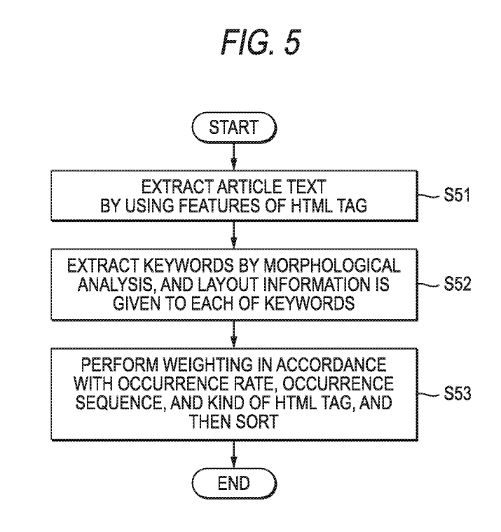

The HTML content retriever 46, which acquires an HTML content as a content having a second format, acquires an HTML content from the server 31 connected to the Internet 30. Next, the HTML content analyzer 47 analyzes and interprets the HTML content. The analysis will be described later in detail with reference to FIGS. 4 and 5. As required, the HTML content analyzer 47 causes the HTML content retriever 46 to acquire an additional content.

Based on a result of the analysis/interpretation of the HTML content, then, the display content generator 48 produces data to be displayed on an Internet browser screen 41a and a keyword candidate screen 51, and outputs the data to the display 18 through the adder 17a, or causes a sound to be generated from the speaker 19.

Commands from the remote-controller receiver 14 are guided to the HTML content retriever 46, the HTML content analyzer 47, and the display content generator 48, and necessary processes are performed in the respective components. For example, the HTML content retriever 46 starts to acquire the content, and the display content generator 48 selects and searches for a keyword.

The command receiver 49 receives a command from the BML browser 40. The HTML browser 41 receives and interprets the HTML content in accordance with the command from the BML browser 40, and executes a process corresponding to the command from the BML browser 40.

After the BML browser 40 receives an event message containing timing control information for the BML content, via the data broadcasting, a command is sent to the HTML browser 41 in conformity with the timing of the event message, thereby controlling the HTML browser 41. According to the configuration, the HTML content can be shown as a linked data broadcasting content which are closely correlated with the data broadcasting.

The embodiment is premised on that the BML browser 40 and the HTML browser 41 are simultaneously activated. However, a case is possible where the BML browser 40 causes the display 18 to display nothing, and only the HTML browser 41 which receives instructions from the BML browser 40 causes the display 18 to perform a display operation.

The command which is transmitted to the HTML browser 41 by the BML browser 40 may be set to be equivalent to an event notifying a manipulation signal for manipulating the HTML browser 41. In this case, the HTML browser 41 may receive a command from the BML browser 40 in the following manner. The HTML browser 41 receives the command as a command which is similar to a command due to a manipulation signal issued by a manipulation module (for example, a remote controller capable of performing wireless communication using an infrared ray) 20, a wired or wireless mouse, or a keyboard, and which sends out a manipulation signal), for example, a manipulation signal of the same type as an event such as up/down/left/right movement of the cursor or decision by the remote controller 20. According to the configuration, it is not necessary to construct a new system for receiving a command from the BML browser 40, in the HTML browser 41.

For example, a script of function Action( ) such as the following can be transmitted from the BML browser 40 to the HTML browser 41.
Browser.sendCommand(“TransitionTo”,http://www.happy-new-year-com);

At this time, the HTML browser 41 may be configured so as to open the web site (http://www.happy-new-year-com), or issue a prompt (for example, display a window for enabling the user to select and decide “Yes” or “No” on a screen by a decision key of the manipulation module 20) or the like. A configuration may be employed where, when the user decides to open a certain web site by using the manipulation module, for example, the web site is opened, and the following keyword extraction process is enabled.

Alternatively, usually, it may be configured so that the user watches a TV program and then opens a preferred web site by himself/herself, and the following keyword extraction process is enabled.

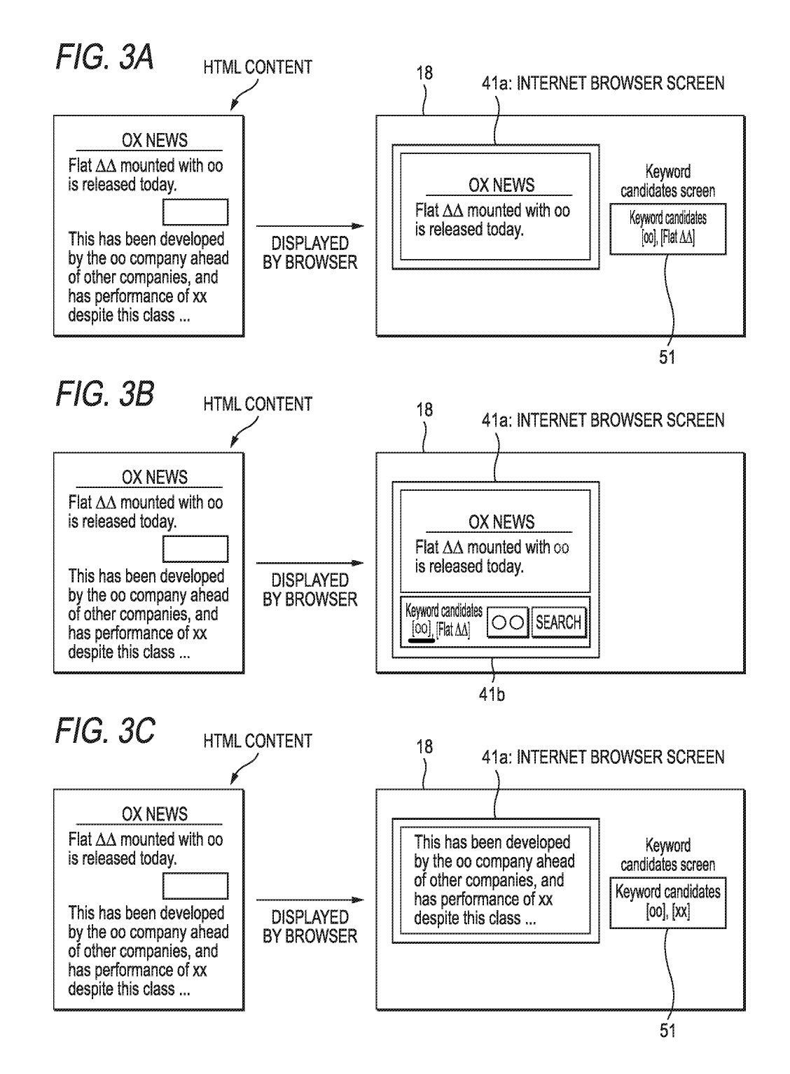

FIGS. 3A to 3C show examples of displaying a content by a browser of an information apparatus such as a television set. Keywords contained in the Internet browser screen 41a which is displayed by the Internet (HTML) browser 41 are extracted by processes of FIGS. 4 and 5 that will be described later, and displayed on the keyword candidate screen 51 that is in the lower right side of FIG. 3A. When the content or display region displayed by the HTML browser 41 is changed, the keyword candidate screen 51 is accordingly updated to the keywords contained in the Internet browser screen 41a. The keyword candidate screen 51 may be always displayed, or displayed in response to a user's manipulation. In FIG. 3A, [∘∘] and [flat ΔΔ] are displayed on the keyword candidate screen 51 as two keyword candidates. The display is performed so that a candidate having a higher evaluation value (here, [∘∘]) is displayed in a more leftward position. When one of the two candidates is selected, a search using the keyword is started. Alternatively, a search screen 41b may have an appearance as shown in FIG. 3B so that the selected keyword is once displayed, and a search using the keyword is started in response to selection of a search. FIG. 3B shows a state where [∘∘] is selected as indicated by the underscore, and this is reflected in a target keyword box which is on the left side of a search button.

FIG. 3C shows an example in which the lower side of the HTML content of FIG. 3A is displayed on the screen. In this case, [××] is displayed as second candidate on the keyword candidate screen 51 which is in the lower right side.

A configuration may be employed where, in the case where the function of the embodiment is not used, the keyword candidate screen portions of FIGS. 3A to 3C are not displayed in accordance with the setting by the user.

FIG. 4 is a view showing the flow of a keyword extraction process in a browser display range used in the embodiment. In the case where the content or display region displayed by a browser is changed, the following process is performed. In the case where a new content is opened, for example, a keyword extraction process in the whole content shown in subsequent FIG. 5 is further performed.

Step S41: A controller (not shown) in the HTML browser 41 determines whether keywords of the whole page have been extracted or not. If the determination is Yes, the process proceeds to step S43, and, if No (in the case where the page content is changed, such as that an HTML content is newly acquired), the process proceeds to next step S42.

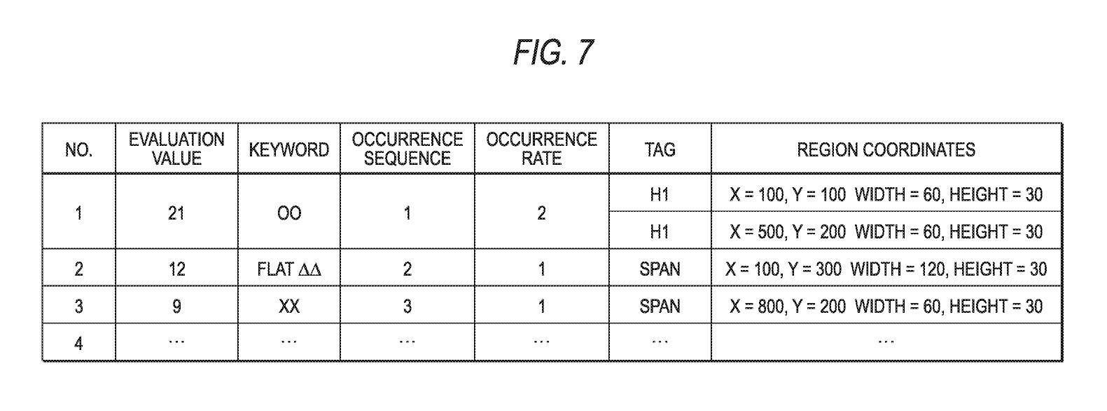

Step S42: The controller calls the process of FIG. 5, and causes the process of extracting keywords in the whole page to be performed. FIG. 7 which will be described later shows a result of sorting of the keywords by the evaluation value.

Step S43: On the result, the display content generator 48 performs filtering of keywords according to the HTML tag, the layout information, and the display region (process of scooping keywords in which the coordinates are included in the display region).

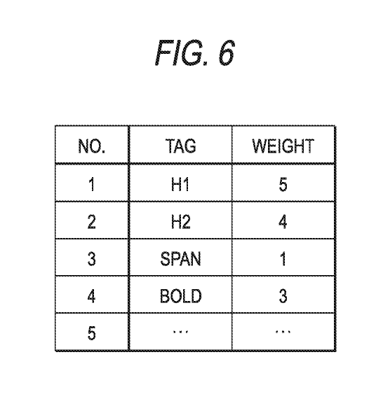

Weighting is performed on each of the occurrence rate, the occurrence sequence, the kind of the HTML tag, and the like, the evaluation value is calculated, for example, in the manner as described below, and sorting is performed in descending order of the evaluation value. First, FIG. 6 shows an example of weighting of each HTML tag which is one kind of the style. For example, the degree of importance of a keyword is defined by using a meaning of a tag, the color, the character size, and the like, and a weight is defined on, for example, five scales of 1 to 5.

A tag H1 means a large heading, and a tag H2 means a small heading. A tag span indicates grouping in a row, and a tag bold indicates a bold face.

Step S44: The display content generator 48 displays keywords and the like based on a result of the filtering.

FIG. 5 shows the flow of the keyword extraction process in the whole content, and the flow is called in the process of FIG. 4. With respect to extraction of an article text which uses features of an HTML tag, there is an open source of the Linux (Trademark) system, or the like, and it is supposed to use such a usual technique. Also with respect to the morphological analysis, there is an open source of the Linux (Trademark) system, or the like, and it is supposed to use such a usual technique.

Step S51: The HTML content analyzer 47 extracts an article text by using features of an HTML tag.

Step S52: The HTML content analyzer 47 extracts keywords in the article text by the morphological analysis. Layout information (the kind of the tag, for example, whether contained in the text or not) is given to each of the keywords.

In the keyword extraction method, only a text of a character string contained in the whole content is extracted based on features of the content, and keywords are extracted from the text by the morphological analysis. At this time, the style and layout information of the sentence are held in each of the keywords.

Step S53: The display content generator 48 weights the keywords in accordance with the occurrence rate, the occurrence sequence, and the kind of the HTML tag, and then sorts the keywords.

In other words, the keywords are weighted in accordance with the occurrence rate in the text, the style, and the layout information, and then sorted. In the method, finally, the sorted keywords are filtered based on the coordinates in the display region.

In the display of a result of sorting, only superior keywords may be displayed, or the whole keywords may be allowed to be displayed by scrolling, a superior portion may be first preferentially displayed, and any kind of highlighting may be further conducted.

The processes of FIGS. 4 and 5 are applicable also to the BML content for a BML browser. The BML content retriever 42 performs a process equivalent to that of the HTML content retriever 46, and the BML content analyzer 43 performs a process equivalent to that of the HTML content analyzer 47, whereby the above-described application is enabled. It is assumed that also a function corresponding to the display content generator 48 is configured in the BML browser.

An example of the calculation of the evaluation value is (evaluation value)=(occurrence rate)×(weight of occurrence rate)+(occurrence sequence)×(weight of occurrence sequence)+(weight of HTML tag).

For example, the evaluation value of the keyword of [∘∘] of No. 1 in the HTML content of FIG. 7 is calculated in the following manner:

(evaluation value)=2×2+(5−1)×3+5=21.

Here, the embodiment is designed so that the weight of the occurrence rate, and that of the occurrence sequence are 2 and 3 or 5 in total. The ratio and the total may be set to adequately refined values. The occurrence sequence is evaluated by a value which is obtained by subtracting the occurrence order from 5 (the value of a sixth or more candidate is assumed to be 0).

FIGS. 3A to 3C show the display examples based on the position in which a keyword candidate having a higher evaluation value is displayed in a more leftward position. Alternatively, the display may be configured in a form in which plural pairs of a keyword candidate and an evaluation value are displayed.

In the case where the content or display region displayed by a browser is changed, the process of FIG. 4 is performed. In the case where a page is newly opened, for example, the keyword extraction process in the whole page which is shown in FIG. 5 is performed, and extracted keywords to which layout information such as shown in FIG. 7 is given are produced. The keywords are filtered into those in the X and Y coordinates (plural sets may be sometimes registered) of the display region of the browser screen, and then displayed as keyword candidates on the keyword candidate screen 51. The keyword candidates may be used as a search keyword in the case where searching is performed after the user selects a desired keyword from the keyword candidates.

In the above-described browser having the function of assisting an keyword input, there is enabled to present keywords having high importance degree by filtering them from keywords extracted from the content and sorted only from the region that is displayed on the screen and is viewable by the user. Even in an apparatus in which characters are hardly input, such as a television set, therefore, it is easy to search for a keyword in which the user is interested during browsing of the content.

In order to solve the problem, in the embodiment, keywords contained in a display region of the content which are displayed by a browser are displayed as related search keywords, and the trouble of inputting a search keyword is avoided.

The embodiment may be configured in a form in which a search engine is in the video display control apparatus 100, and realizes a service in which data accumulated in the video display control apparatus 100 are searched as a search object in place of data existing in the Internet.

The invention is not limited to the embodiment, and may be further implemented by modifying in various manners without departing from the spirit of the invention.

Plural components disclosed in the above-described embodiment may be appropriately combined with each other, whereby various inventions may be formed. For example, some components may be omitted from the whole components indicated in the embodiment, and moreover components of different embodiments may be adequately combined with each other.

1. A content-browseable data display apparatus comprising:
a browsing module which browses a content;
an extracting module which extracts keywords from the content;
a displaying module which obtains an evaluation value for each keyword, and which selectably displays the keywords based on the evaluation values; and
a searching module which performs a keyword search on a search object by using a keyword selected from the displayed keywords,
wherein the displaying module performs filtering so as to scoop the keywords contained in a displaying region where the browsing module displays an HTML content, and displays the scooped keywords.

2. The data display apparatus of claim 1,
wherein the evaluation values are obtained based on occurrence rates of the keywords, an occurrence sequence of the keywords, or weights of HTML tags relating to the keywords.

3. The data display apparatus of claim 1,
wherein the extracting module extracts a content text based on a feature of the content.

4. The data display apparatus of claim 2,
wherein the extracting module extracts keywords further from the content text by a morphological analysis.

5. The data display apparatus of claim 1,
wherein the weighting is performed based on occurrence rates of the keywords, a style, or layout information.

6. A data display method in a content-browseable data display apparatus, the method comprising:
a browsing step of browsing a content;
an extracting step of extracting keywords from the content;
a displaying step of obtaining an evaluation value for each keyword, and selectably displaying the keywords based on the evaluation values; and
a searching step of performing a keyword search on a search object by using a keyword selected from the displayed keywords,
wherein, in the displaying step, filtering is performed so as to scoop the keywords contained in a displaying region where the browsing step displays an HTML content, and the scooped keywords are displayed.
